(19) United States
(12) Patent Application Publication
(10) Pub. No.: US 2010/0104013 A1
(43) Pub. Date: Apr. 29, 2010

(54) MULTIPLEXING CONTROL UNIT

(75) Inventors: Takashi MATSUMOTO, Kawasaki (JP); Takayuki SUZUKI, Sagamihara (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/578,610

(22) Filed: Oct. 14, 2009

(30) Foreign Application Priority Data
Oct. 29, 2008 (JP) 2008-277834

(51) Int. Cl. H04N 11/02

(52) U.S. Cl. 375/240.15; 375/E07.243

(57) ABSTRACT

Provided is a multiplexing control unit operable to execute multiplex (MUX) and demultiplex (DEMUX), and enhanced in its processing performance. The multiplexing control unit includes a transport stream (TS) buffer, a multiplex-processing part, a video buffer and an audio buffer. When supplied with coded video and audio data from video and audio buffers, the multiplex-processing part conducts MUX, and on the other executes DEMUX on TS data stored in the TS buffer thereby to produce coded video and audio data. MUX and DEMUX processes by the multiplex-processing part are executed in sets of more than one frame processed according to moving-picture compression coding. Before start of execution of the process, whether or not the requirement of preparation for the execution is satisfied is judged inside the device, in which the judgment is made by checking storing states of the buffers.

### CLAIM OF PRIORITY

The Present application claims priority from Japanese application JP 2008-277834 filed on Oct. 29, 2008, the content of which is hereby incorporated by reference into this application.

### FIELD OF THE INVENTION

The present invention relates to a multiplexing control unit which serves as a multiplexer operable to conduct a multiplex process and as a demultiplexer operable to execute a demultiplex process. Particularly it relates to a technique useful for enhancement of the processing performance thereof.

### BACKGROUND OF THE INVENTION

In recent years, moving picture recording and viewing on or through mobile devices including mobile phones, portable contents players and portable game machines have become common because of the enhancement of performance of system LSIs—LSI stands for Large Scale Integrated Circuit—and the reduction in power consumption thereof, and the increase in capacity of storages including flash memories. The advancement of image-processing techniques has made possible to handle high-definition and high-image-quality digital contents, which have been achieved by digital video cameras, stationary type television-broadcasting receivers, personal computers abbreviated to PCs, and other devices so far.

The 3rd- and 3.5th-generation mobile phones, which have been in common use now, are primarily composed of a baseband processing part in charge of a communication function, and a multimedia processing part in charge of graphics and other processes used for record and reproduction or play of still and moving pictures, voice and sound, and music, and for electronic games and other things. To cope with the diversification of multimedia processes and the enhancement of functions, the following means have been in existence, for example: LSI with CPU exclusively for multimedia processing; and an arrangement such that LSI dedicated to multimedia processing is provided separately. Incidentally, CPU stands for Central Processing Unit.

However, mobile devices of portable type such as mobile phones are inferior to digital video cameras, stationary type television-broadcasting receivers and personal computers in CPU performance and in hardware performance, such as the memory capacity of a semiconductor memory, e.g. random access memory, hereinafter referred to as RAM. This is because with such mobile devices, it is taken into account to make longer the operating time while suppressing the power consumption, and there is a large restriction in mounting space. Therefore, to materialize an image-processing function comparable to those of digital video cameras, stationary type television-broadcasting receivers and PCs in mobile devices of portable type, it becomes necessary to exercise ingenuity for implementation because of the hardware restriction of mobile devices of portable type.

Meanwhile, a demultiplexer and a multiplexer are used for viewing television, and photographing with a digital video camera, for example. A demultiplexer conducts a demultiplex process (hereinafter referred to as DEMUX process for short), whereas a multiplexer executes a multiplex process (MUX process).

In DEMUX process, a transport stream, consisting of various multiplexed data, undergoes extraction and then data-format conversion from TS (Transport Stream) to PES (Packetized Elementary Stream) and ES (Elementary Stream) into desired data, which can be read by a decoder.

In contrast, in MUX process, various packetized elementary streams and elementary streams are divided into transport stream packets, which are termed TS packets for short and make constitutional units of transport streams, and then multiplexed.

Standards under which transport streams are adopted include e.g. MPEG-2 moving-picture encoding/decoding system and AVCHD (Advanced Video Codec High Definition), and they are used in digital broadcasting standards of various countries including Japan and used for high-vision digital video cameras. Now, it is noted that AVCHD is one of standards for a video camera to record a high-vision image, and is a trademark of Panasonic Corporation and Sony Corporation.

TS packets constituting a transport stream are data of 188 or 192 bytes, which are composed of header data and payload data.

In the header portion, information concerning the transport stream is recorded. In the payload portion, in the case of encoded data such as image and voice and sound, a packetized elementary stream produced by packetizing elementary streams in the unit of the reproduction time is recorded.

Further, in the case of pieces of control information necessary for decoding and reproducing a packetized elementary stream, which are termed Program Specification Information (PSI) and Service Information (SI), and additional information including Electronic Program Guide (EPG), for example, data depending on their applications are divided so that they can be held on a TS packet size basis, and stored in the payload portion.

Incidentally, the Program Specification Information (PSI) is information necessary for selecting a program, and contains Program Association Table (PAT), Program Map Table (PMT), Network Information Table (NIT) and Conditional Access Table (CAT). The Service Information (SI) is a generic designation of tables including Service Description Table (SDT) and Event Information Table (SIT), which are defined for e.g. display of the name of a channel and program information and for convenience in selecting a program. These various technical terms of digital broadcasting are described by Hiroyuki Miyake et al. in “Digital Housou-jushinki ni okeru Senkyoku-gijutsu (Tuning Technology of Digital Broadcast Receiver)”, SANYO TECHNICAL REVIEW, VOL. 36, No. 1, June 2004, PP. 31-44.

To distinguish among various payloads included in transport stream packets, a packet identifier (PID) contained in each header portion is used. In DEMUX process, the packet identifier (PID) is observed to extract the payload portion of a TS packet of interest, whereby a desired set of payloads is extracted. In MUX process, a packetized elementary stream and a program specification information (PSI)/service information (SI) are divided into transport stream payloads, to which TS headers are further added thereby to produce TS packets, and then the packets thus produced are gathered together into a transport stream. In this process, for the purpose of arranging the transport stream to have a resistance property against an error, packets of various packet identifiers (PID) are mixed up and located discretely so as to avoid that packets of certain packet identifiers (PID) are concentrated in one area.

### SUMMARY OF THE INVENTION

In recoding, video data taken by a camera of a digital video camera system, and audio data captured by a microphone thereof are encoded into video and audio elementary streams by video and audio encoders, respectively. In this step, the encode is carried out in units of frames (pictures). The video and audio elementary streams are packetized into packetized video and audio elementary streams, respectively.

Packetized video and audio elementary streams are supplied to an input of a multiplexer, whereby the multiplexer produces multiplexed transport streams through its output. Then, the multiplexer provides video and audio encoders with a notice that the first MUX process has been completed. On receipt of this, the encode process of subsequent video and audio elementary streams and the packetizing process of packetized elementary streams (PES) are conducted.

As described above, at the time of recording, as to MUX process, if encode and multiplex processes of videos and audios corresponding to a plurality of frames are executed, the numbers of inter-task communications and interruptions are increased, and the overhead of processing caused by them leads to the deterioration of the whole system in performance of processing including moving-picture compression coding, and multiplex. This problem became clear from the study by the inventors.

On the other hand, in reproducing a shot image from a storing medium after recording, transport streams from the storing medium are supplied to an input of a demultiplexer, and thereby separated into video and audio data. The resultant video and audio data are supplied to inputs of video and audio decoders, from which decompressed data used for video and audio reproduction are output. Then, the video and audio decoders supply the demultiplexer with a notice that the video and audio decode processes have been completed. Thus, DEMUX process on the subsequent transport stream is started.

As described above, also in reproduction, if DEMUX process of a transport stream and the decode process of an elementary stream (ES) are executed, the numbers of inter-task communications and interruptions are increased, and the overhead of processing caused by them leads to the deterioration of the whole system in performance of processing including moving-picture decompression decoding, and multiplex. This problem became clear from the study by the inventors.

The invention was made by the inventors after the study prior to the invention as described above.

Therefore, it is an object of the invention to enhance the processing performance of a multiplexing control unit.

Further, it is another object of the invention to decrease the numbers of inter-task communications and interruptions in MUX process thereby to reduce the overhead owing to these processing steps, and therefore to enhance the system in performance of processing including moving-picture compression coding, and multiplex.

In addition, it is another object of the invention to decrease the numbers of inter-task communications and interruptions in DEMUX process thereby to reduce the overhead owing to them, and therefore to enhance the system in performance of processing including moving-picture decompression decoding, and multiplex.

The above and other objects of the invention and novel features thereof will become clear from the description hereof and the accompanying drawings.

Of the invention herein disclosed, the preferred embodiments will be described below briefly.

A multiplexing control unit (100) operable to control MUX and DEMUX processes according to a preferred embodiment of the invention includes a transport stream (TS) buffer (222), a multiplex-processing part (210), a video buffer (242), and an audio buffer (252).

Coded video data and coded audio data are supplied from the video buffer (242) and audio buffer (252), and then the multiplex-processing part (210) executes MUX process. On the other hand, the multiplex-processing part (210) executes DEMUX process on transport stream data stored in the TS buffer (222), whereby coded video data and coded audio data can be produced (see FIG. 3).

The MUX process and DEMUX process by the multiplex-processing part (210) are executed in sets of more than one frame processed according to the moving-picture compression coding.

Before start of the MUX process or DEMUX process, it is judged in the multiplexing control unit (100) whether or not the requirement of preparation for the execution is satisfied.

The judgment about whether or not the requirement of preparation for the execution is satisfied is made by checking the storing state of the buffer (242, 252, 222) (see FIGS. 4 and 5).

Of the invention herein disclosed, an effect achieved by the preferred embodiments will be described below briefly.

The invention can increase the processing performance of the multiplexing control unit.

According to the invention, the following are made possible: to reduce the number of inter-task communications and the number of interruption processes in multiplex (MUX) and demultiplex (DEMUX) process thereby reducing an overhead owing to these processes; and to enhance the processing performance of a system including moving-picture compression coding, moving-picture decompression decoding and multiplex processing.

These and other features, objects and advantages of the present invention will become more apparent from the following description when taken in conjunction with the accompanying drawings.

### BRIEF DESCRIPTION OF THE DRAWINGS

FIG. 1 is a diagram showing a hardware configuration of a mobile phone according to an embodiment of the invention;

FIG. 2 is a diagram showing a configuration of a multiplexing control unit which materializes a multiplexer/demultiplexer built in a mobile phone terminal according to an embodiment of the invention;

FIG. 3 is a diagram showing an internal configuration of the multiplexing control unit according to an embodiment of the invention shown in FIG. 2;

FIG. 4 is a flowchart for explaining the flow of control of the demultiplex process by the multiplexing control unit according to the embodiment of the invention shown in FIG. 3;

FIG. 5 is a flowchart for explaining the flow of control of the multiplex process by the multiplexing control unit according to the embodiment of the invention shown in FIG. 3;

FIG. 6 is a flowchart for explaining the flow of control of another demultiplex process by the multiplexing control unit according to the embodiment of the invention shown in FIG. 3;

FIG. 7 is a flowchart for explaining the detail of the demultiplex process (DEMUX process 1) involved with Step 508 in the control flow shown in FIG. 6;

FIG. 8 is a flowchart for explaining the detail of the demultiplex process (DEMUX process 2) involved with Step 512 in the control flow shown in FIG. 6;

FIG. 9 is a flowchart for explaining the detail of the demultiplex process (DEMUX process 3) involved with Step 514 in the control flow shown in FIG. 6;

FIG. 10 is a diagram for explaining a hierarchical structure involved with a moving-picture coding scheme;

FIG. 11 is a diagram showing a configuration in which a tuner for receipt of a television broadcast is connected with the system of FIG. 2; and

FIG. 12 is a diagram showing, on the assumption that the system of FIG. 11 is an independent coprocessor system, a configuration in which the coprocessor system is connected with a host processor of a host system.

### DETAILED DESCRIPTION OF THE PREFERRED EMBODIMENTS

### 1. Summary of the Preferred Embodiments

The preferred embodiments of the invention herein disclosed will be outlined first. Here, the reference numerals for reference to the drawings, which are accompanied with paired round brackets, only exemplify what the concepts of parts or components referred to by the numerals contain.

[1] A multiplexing control unit (100) according to a preferred embodiment of the invention includes: a TS buffer (222); a multiplex-processing part (210); a video buffer (242); and an audio buffer (252), and it executes MUX process.

The video buffer (242) can store coded video data, and the audio buffer (252) can store coded audio data.

The multiplex-processing part (210) is supplied with the coded video data and coded audio data from the video buffer (242) and audio buffer (252) respectively. The multiplex-processing part (210) executes MUX process on the coded video data and coded audio data.

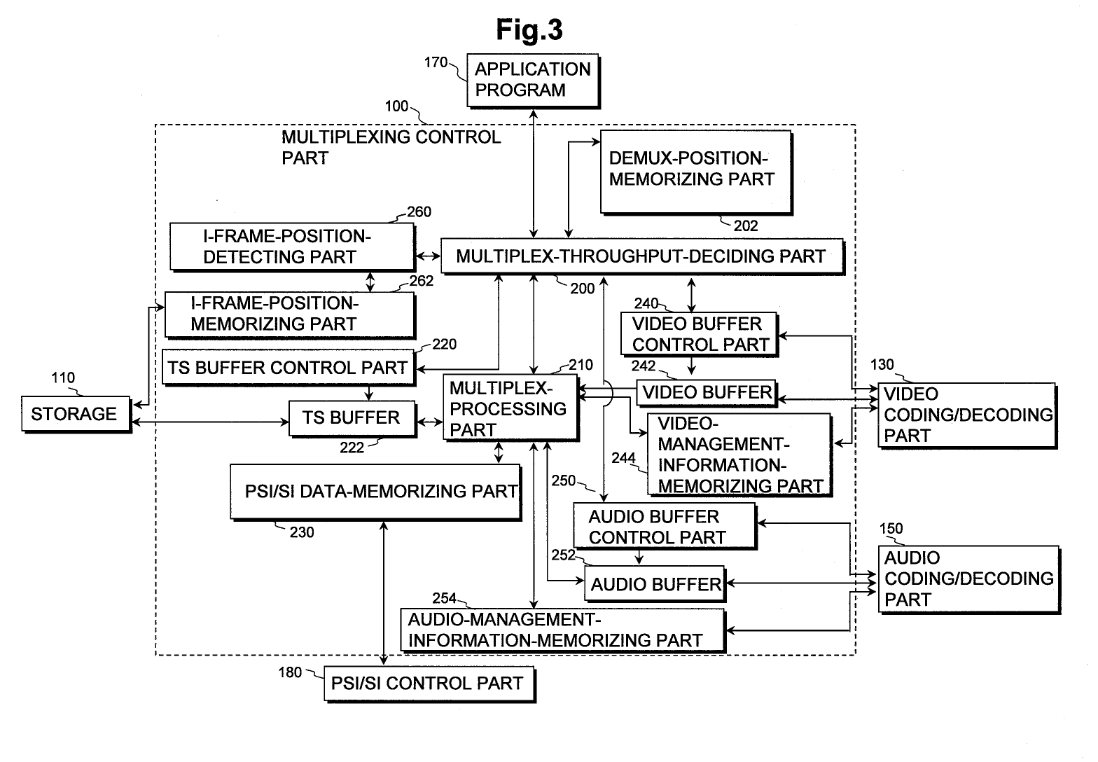

Transport stream data produced by MUX process by the multiplex-processing part (210), and subjected to moving-picture compression coding can be stored in the TS buffer (222) (see FIG. 3).

Supplies of the coded video data and coded audio data to the multiplex-processing part (210) are executed in sets of more than one frame processed according to the moving-picture compression coding (Step 410).

Before start of execution of MUX process, it is judged in the multiplexing control unit (100) whether or not a requirement of preparation for execution of MUX process is satisfied (Steps 400-408).

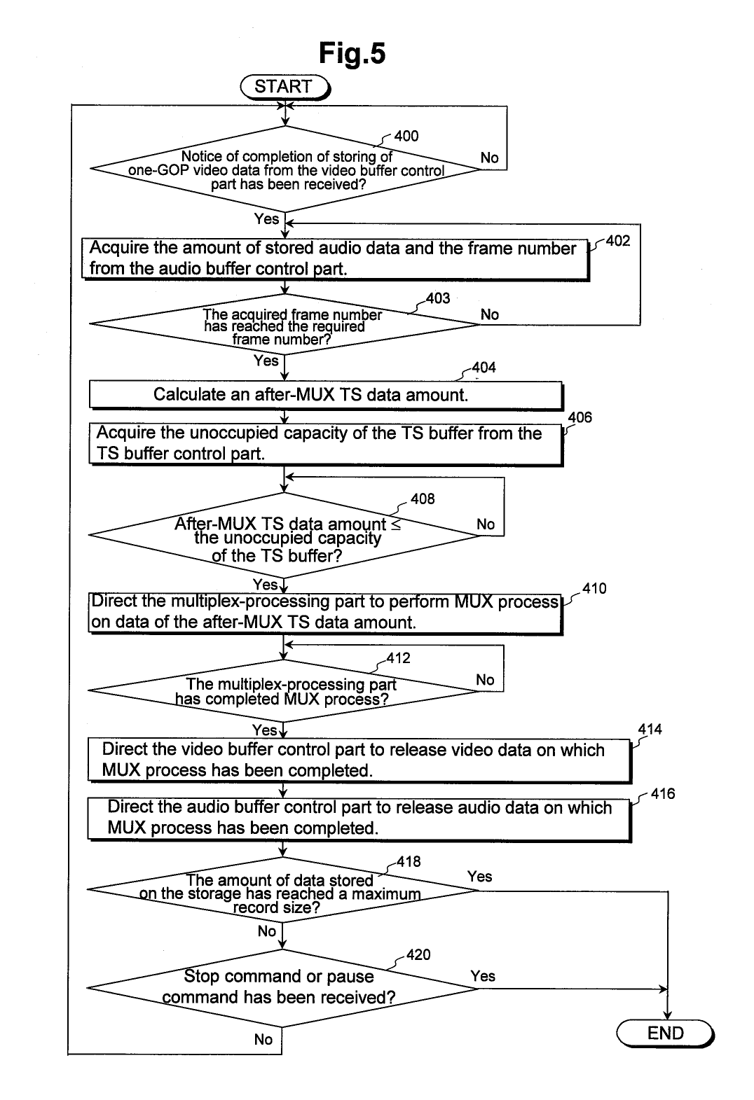

The judgment on whether or not the requirement of preparation for the execution is satisfied is made by (Step 400) checking a storing state of the coded video data in the video buffer (242), (Step 403) checking a storing state of the coded audio data in the audio buffer (252), and (Step 408) checking a storing state of the transport stream data in the TS buffer (222) (see FIG. 5).

According to the above embodiment, before start of execution of MUX process which is executed in sets of more than one frame produced according to the moving-picture compression coding, the storing states of the buffers (242, 252, 222) are checked (Steps 400, 403, 408). Therefore, in comparison to a case that whether to execute MUX process not is judged for each frame, the number of inter-task communication and interruption processes in MUX process can be decreased and therefore the overhead owing to these processes can be reduced.

According to a preferred embodiment, the more than one frame processed in MUX process includes an I-frame which is an intra-screen prediction coded picture in a moving-picture coding scheme, a P-frame which is a forward prediction coded picture and a B-frame which is a bi-directional prediction coded picture.

The more than one frame is coded video data at least including the I-frame to a frame just before a next I-frame (see FIG. 5).

According to another preferred embodiment, the more than one frame corresponds to one group of pictures (GOP) substantially (see FIG. 5).

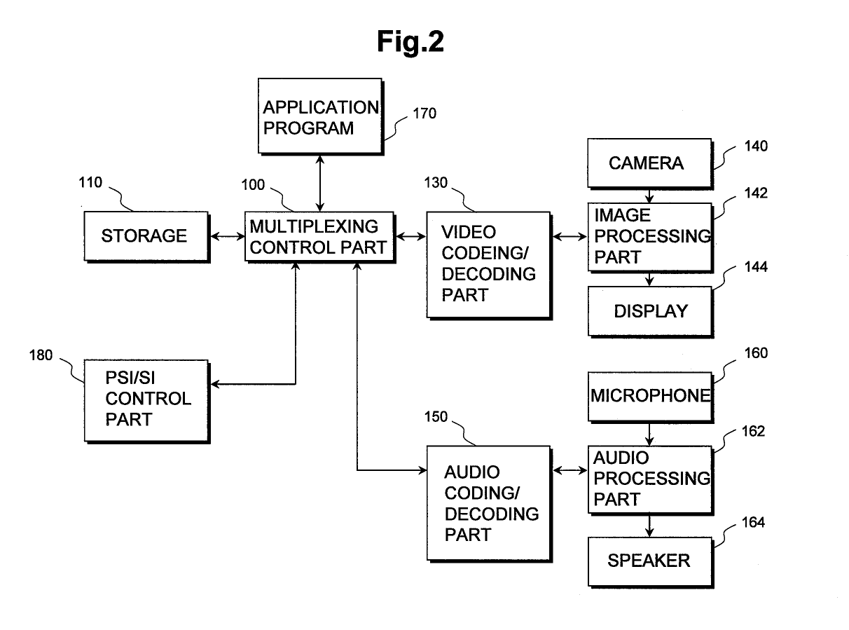

According to a more preferred embodiment, the coded video data which can be stored in the video buffer (242), the coded audio data which can be stored in the audio buffer (252) are based on image data captured by a camera of a digital video camera system and audio data captured by a microphone respectively (FIG. 2).

According to a still more preferred embodiment, the image data captured by the camera is converted into the coded video data by a video coding/decoding part (130), and the audio data captured by the microphone is converted into the coded audio data by an audio coding/decoding part (150) (see FIG. 2).

According to another more preferred embodiment, the multiplexing control unit (100) further includes a data-memorizing part (230) capable of storing program information (PSI/SI) as broadcast-associated information.

The coded video data and coded audio data are supplied to the multiplex-processing part (210) from the video buffer (242) and audio buffer (252), respectively, and the program information (PSI/SI) is supplied from the data-memorizing part (230), whereby the multiplex-processing part (210) executes MUX process on the coded video data, coded audio data and the program information (See FIG. 2).

According to another specific embodiment, the judgment on whether or not the requirement of preparation for the execution is satisfied is made by a judging part (200) inside the multiplexing control unit (100).

[2] When viewed from another aspect of the invention, a multiplexing control unit (100) according to a preferred embodiment includes a TS buffer (222), a multiplex-processing part (210), a video buffer (242), and an audio buffer (252), and executes DEMUX process.

Transport stream data subjected to moving-picture compression coding, on which the multiplex-processing part (210) executes DEMUX process, can be stored in TS buffer (222).

The multiplex-processing part (210) executes DEMUX process on the transport stream data stored in TS buffer (222), whereby coded video data and coded audio data can be produced.

The coded video data produced by the multiplex-processing part (210) can be stored in the video buffer (242), and the coded audio data produced by the multiplex-processing part (210) can be stored in the audio buffer (252) (see FIG. 3).

DEMUX process by the multiplex-processing part (210) is executed in sets of more than one frame processed according to the moving-picture compression coding (Step 312).

Before start of execution of DEMUX process, it is judged in the multiplex-processing part (100) whether or not a requirement of preparation for execution of DEMUX process is satisfied (Steps 300-308).

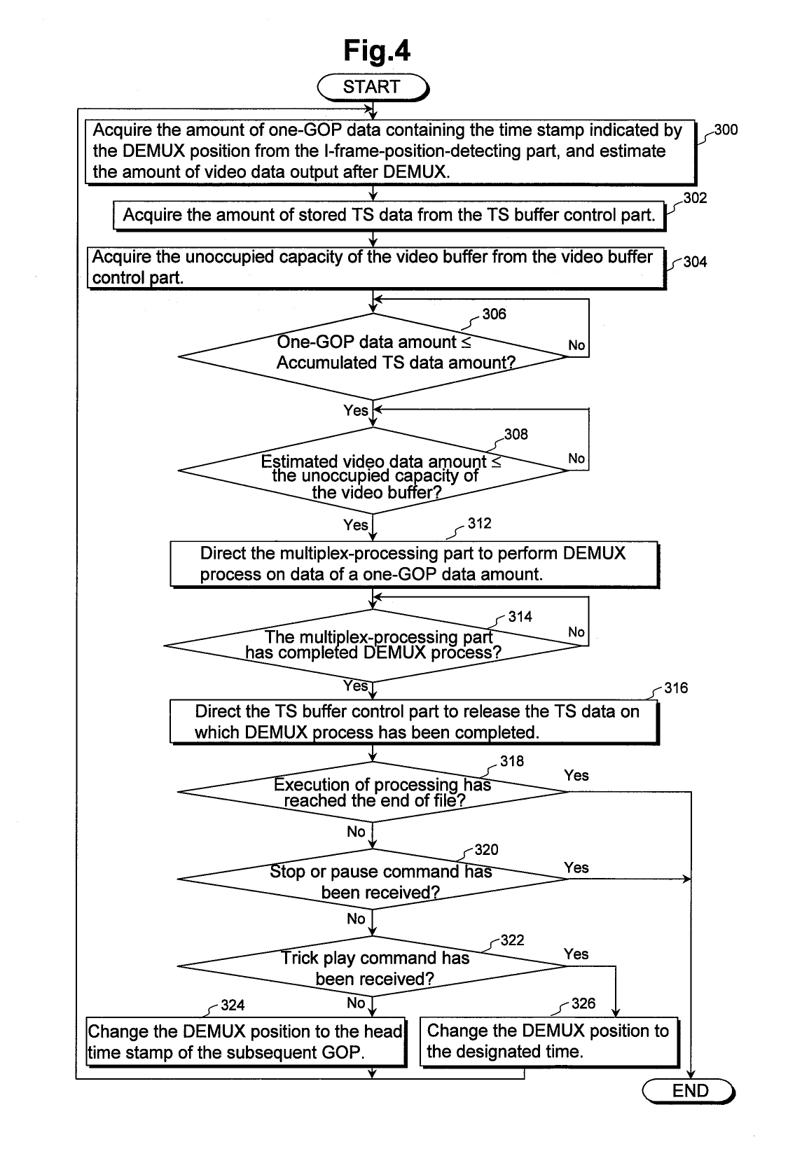

The judgment on whether or not the requirement of preparation for the execution is satisfied is made by (Step 306) checking a storing state of the transport stream data of the TS buffer (222), and (Step 308) checking a storing state of the decoded video data of the video buffer (242) (see FIG. 4).

According to the above embodiment, before start of execution of DEMUX process which is to be executed in sets of more than one frame processed according to the moving-picture compression coding, the checking of a storing state of each buffer (242, 222) is performed (Step 306, 308). Hence, in comparison to the case of judging whether or not to execute DEMUX process on an individual frame basis, the number of inter-task communications in DEMUX process can be made smaller, and the overhead in processing of moving-picture compression coding can be reduced.

Further, according to a preferred embodiment, the more than one frame processed according to DEMUX process includes an I-frame which is an intra-screen prediction coded picture in a moving-picture coding scheme, a P-frame which is a forward prediction coded picture and a B-frame which is a bi-directional prediction coded picture.

The more than one frame is coded video data at least including the I-frame to a frame just before a next I-frame (see FIG. 4).

According to another preferred embodiment, the more than one frame corresponds to one group of pictures (GOP) substantially (see FIG. 4).

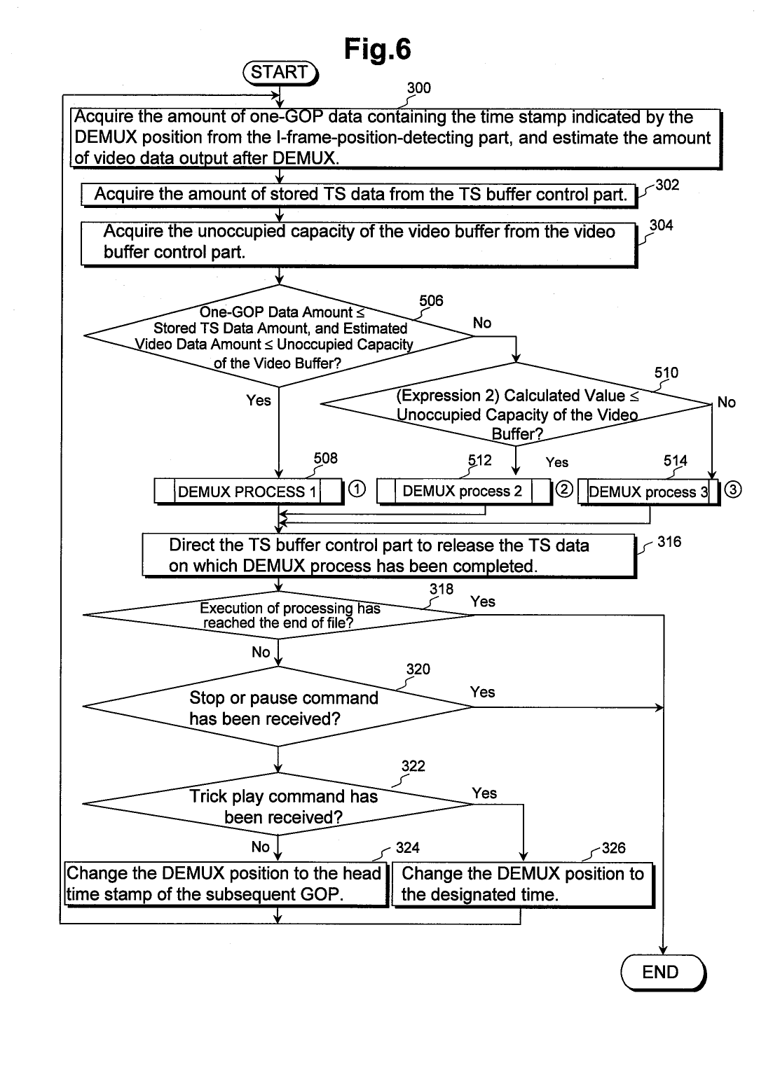

According to still another preferred embodiment, even in case that the requirement of preparation for the execution is judged not to be perfectly satisfied, execution of the DEMUX process is started only on the transport stream data stored in the TS buffer (222) by (“No” of Step 506) confirming that the data amount of the transport stream data stored in TS buffer (222) is smaller than a data amount of the one group of pictures (GOP), and (“Yes” of Step 510) confirming that an unoccupied capacity of the video buffer (242) is larger than an effective stored data amount of the TS buffer (222) (see FIG. 6; Step 512, FIG. 8; Step 700).

According to another preferred embodiment, after completion of the execution of DEMUX process only on the transport stream data stored in the TS buffer (222), the multiplexing control unit waits for remaining transport stream data of the one GOP to be stored in the TS buffer (222) (Step 704), and further waits for a required unoccupied capacity to be saved in the video buffer (242) (Step 706), and thereafter (Step 708) execution of DEMUX process on the remaining transport stream data stored in the transport stream buffer is started (see FIG. 8).

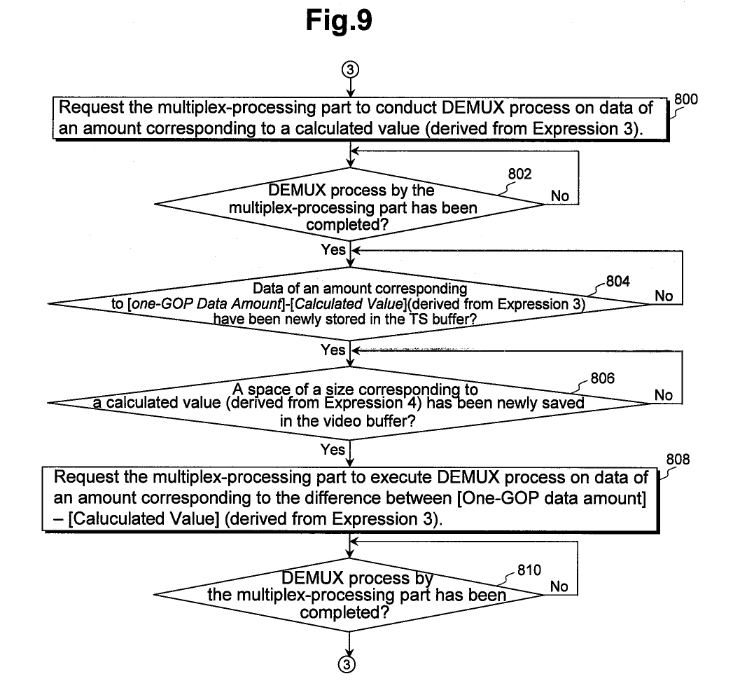

According to still another preferred embodiment, even in case that the requirement of preparation for the execution is judged not to be perfectly satisfied, after (“No” in Step 506) confirming that the data amount of the transport stream data stored in the TS buffer (222) is smaller than a data amount of the one group of pictures (GOP), and (“No” in Step 510) confirming that an unoccupied capacity of the video buffer (242) is smaller than an effective stored data amount of the TS buffer (222), execution of the DEMUX process is started only on the transport stream data stored in the TS buffer (222) and corresponding to the unoccupied capacity of the video buffer (242) (see FIG. 6; Step 514, FIG. 9; Step 800).

According to a specific embodiment, after completion of the execution of DEMUX process only on the transport stream data stored in the TS buffer (222), and corresponding to the unoccupied capacity of the video buffer (242), the multiplexing control unit waits for remaining transport stream data of the one group of pictures (GOP) to be stored in the TS buffer (222) (Step 804), and waits for a required unoccupied capacity to be saved in the video buffer (242) (Step 806), and then execution of the DEMUX process on the remaining transport stream data stored in the TS buffer (222) is started (Step 808) (see FIG. 9).

According to a more specific embodiment, the coded video data and coded audio data produced by the multiplex-processing part (210) are converted into decoded video data and decoded audio data by a video coding/decoding part (130) and an audio coding/decoding part (150), respectively (see FIGS. 2 and 3).

According to a still more specific embodiment, the transport stream data which can be stored in the TS buffer (222) is based on data acquired from a storage (110) of a portable system (see FIG. 2).

The multiplexing control unit (100) according to another more specific embodiment further includes a data-memorizing part (230) capable of storing program information (PSI/SI) as broadcast-associated information.

The multiplex-processing part (210) executes DEMUX process on the transport stream data stored in the TS buffer (222), whereby the coded video data and coded audio data can be produced, and the program information (PSI/SI) can be produced.

The program information (PSI/SI) produced by the multiplex-processing part (210) can be stored in the data-memorizing part (230) (see FIG. 3).

According to the most specific embodiment, the judgment on whether or not the requirement of preparation for the execution is satisfied is made by a judging part (200) inside the multiplexing control unit (100).

### 2. Further Detailed Description of the Preferred Embodiments

Now, the embodiments will described further in detail. It is noted that in all the drawings for description of the best mode for carrying out the invention, parts or compornents having identical functions are identified by the same reference numeral or character, and the repeated description thereof is omitted.

### <<Configuration of the Mobile Phone>>

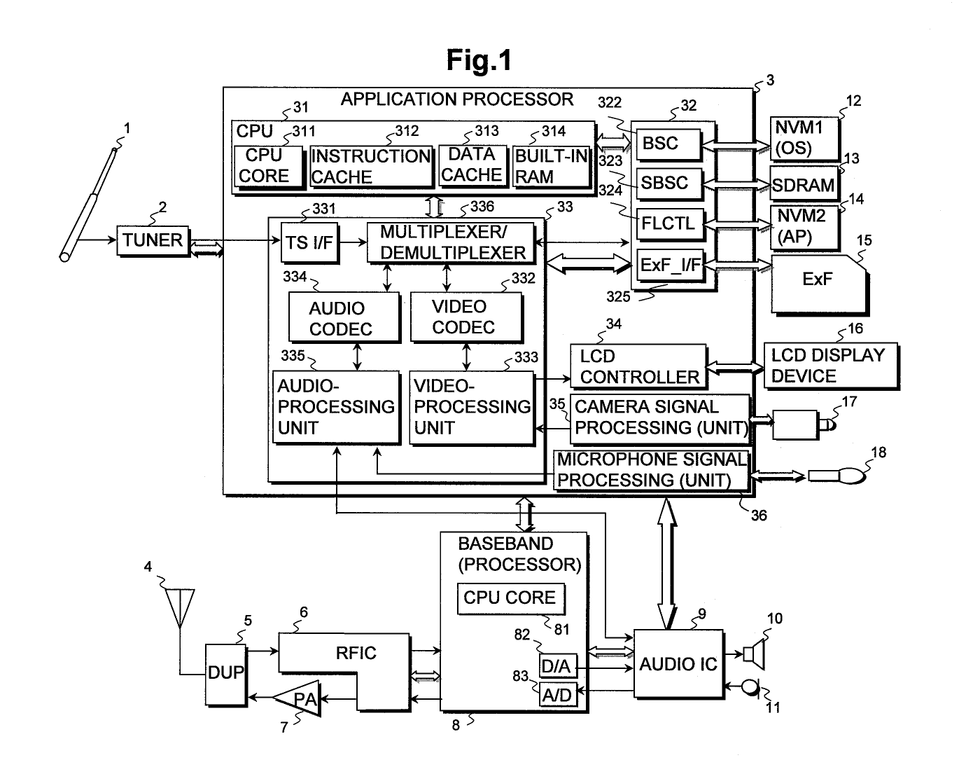

FIG. 1 is a diagram showing a hardware configuration of a mobile phone according to an embodiment of the invention.

To materialize functions of a mobile phone, the mobile phone of FIG. 1 includes: an antenna 4; a duplexer 5; an RF analog signal processing IC 6; an RF power amplifier 7; a baseband processor 8; an application processor 3; an audio IC 9; a speaker 10; and a microphone 11.

Also, the mobile phone of FIG. 1 includes a rod antenna 1, a terrestrial digital broadcast/tuner module 2 and the application processor 3, which is for making possible to watch a terrestrial digital broadcast and to record it on an external nonvolatile semiconductor memory device according to a reservation. The terrestrial digital broadcast/tuner module 2 is a tuner module operable to receive a terrestrial digital broadcast.

Further, the LCD display device 16 connected with the application processor 3, and the audio IC 9 connected with the baseband processor 8 are used to enable the functions of the mobile phone and viewing of a terrestrial digital broadcast. In addition, the camera 17, microphone 18 and external memory device 15, which are connected with the application processor 3, allow a digital video camera system to take a moving picture.

While this is not shown in the drawing, an operating device having an operation key and/or an operation button is connected with the application processor 3. Therefore, the following are made possible by an end user operating the operating device: talking over the mobile phone; viewing and preprogrammed recording of a terrestrial digital broadcast; and taking a moving picture by use of a camera.

### <<Function of the Mobile Phone>>

The baseband processor 8 includes a CPU core 81 operable to control the action of the mobile phone. The CPU core 81 of the baseband processor 8 is electrically connected with the application processor 3. In response to an operation of the operating device by an end user, a control signal is transmitted from the application processor 3 to the CPU core 81 of the baseband processor 8, whereby a phone call over the mobile phone is started.

An RF receive signal accepted through the antenna 4 from a base station is supplied to a receive-signal processing part in RF IC 6 through the duplexer 5. The RF receive signal is converted down into an analog baseband receive signal by the receive-signal processing part of RF IC 6. The analog baseband receive signal is converted into a digital-receive-baseband signal by an A/D converter in RF IC 6.

The digital-receive-baseband signal supplied by the A/D converter of the RF IC 6 undergoes a signal demodulation in the baseband processor 8, and then a digital-to-analog conversion by the D/A converter 82, whereby an audio-output receive signal is produced. The audio-output receive signal is amplified by the audio IC 9, and thereafter supplied to the speaker 10.

After being amplified in the audio IC 9, an audio-input transmit signal of the microphone 11 is subjected to an analog-to-digital conversion by the A/D converter 83 of the baseband processor 8 and thus converted into a digital signal, which is further subjected to a signal modulation processing in the baseband processor 8 and thereby converted into a digital-transmit-baseband signal. The digital-transmit-baseband signal is converted into an analog baseband transmit signal by the digital-to-analog conversion by the D/A converter of RF IC 6. The analog baseband transmit signal is converted up into an RF transmit signal by the receive-signal processing part of RF IC 6. The RF transmit signal is amplified by the RF power amplifier 7, and then sent to a base station through the duplexer 5 and antenna 4.

To the terrestrial digital broadcast/tuner module 2, baseband processor 8 and audio IC 9, the application processor 3 is connected.

### <<Configuration of the Application Processor>>

The application processor 3 includes: a central processing unit (CPU) 31; an external memory interface unit 32; a multimedia processing part 33; an LCD controller 34; a camera signal processing unit 35; and a microphone signal processing unit 36.

CPU 31 includes: a CPU core 311; an instruction cache memory 312; a data cache memory 313; and a built-in RAM 314.

The external memory interface unit 32 includes: a first external memory interface 322 connected to a flash memory used as the first external nonvolatile semiconductor memory device 12; and a second external memory interface 323 connected to a synchronous dynamic random access memory (SDRAM) used as the first external volatile memory device 13.

In the flash memory 12, a software program of an operating system (OS) for basic actions of a mobile phone serving as a mobile terminal can be stored. In the SDRAM 13, various data for a receiver, which enable viewing or preprogrammed recording of a terrestrial digital broadcast during the time the mobile phone is in operation, can be stored.

The external memory interface unit 32 further includes: a third external memory interface 324 connected to a flash memory used as the second external nonvolatile semiconductor memory device 14; and an extended external memory interface 325 connected to a flash memory card used as the external memory device 15 which is to be inserted in and connected with a mobile phone serving as a mobile terminal.

In the flash memory 14, various application software programs for a mobile phone and a terrestrial digital broadcast receiver, which can be implemented on the operating system (OS) stored in the flash memory 12, can be stored. The external memory device 15 may be composed of a flash memory card, a hard disk drive (HDD) or the like. Various data and contents, which are to be memorized in a nonvolatile form in a case that an end user specifies nonvolatile memorization in connection with a mobile phone, a terrestrial digital broadcast receiver and the taking of a moving picture by a digital video camera system, can be stored in the external memory device 15.

The multimedia processing part 33 includes: a transport stream input interface 331; a video codec 332; an image-processing unit 333; an audio codec 334; an audio-processing unit 335; and a multiplexer/demultiplexer 336. In addition, the multimedia processing part 33 is connected with the LCD controller 34 and audio IC 9 for image display and audio output by use of the LCD display device 16 and speaker 10. Further, the multimedia processing part 33 is connected with the camera signal processing unit 35 and microphone signal processing unit 36 to enable the taking of a moving picture by use of the camera 17 and microphone 18 of the digital video camera system.

A transport stream from the terrestrial digital broadcast/tuner module 2 contains fixed-length packets of video information, audio information and associated transmit information of a compression coding format of a digital broadcasting program received by the terrestrial digital broadcast/tuner module 2. The associated information contains program specification information (PSI) and service information (SI).

### <<Taking of Moving Picture by the Digital Video Camera System>>

The camera 17, microphone 18 and external memory device 15 connected with the application processor 3 allow the digital video camera system to take a moving picture. Specifically, the multimedia processing part 33 is connected to the camera signal processing unit 35 and microphone signal processing unit 36 to enable the taking of a moving picture by use of the camera 17 and microphone 18 of the digital video camera system. After being processed by the camera signal processing unit 35, a video input signal from the camera 17 is supplied to the image-processing unit 333. Then, it undergoes up- or down-scaling, image synthesis and quality control, and other processing, and is input to the video codec 332. After being processed by the microphone signal processing unit 36, an audio input signal from the microphone 18 is supplied to the audio-processing unit 335. Then, it undergoes tone control and other processing, and is input to the audio codec 334. Audio coding information and audio coding information produced by the video codec 332 and audio codec 334 are converted to a desired file format by the multiplexer/demultiplexer 336, and thereafter stored in the external memory device 15 through the extended external memory interface 325.

### <<Moving Picture Coding Method>>

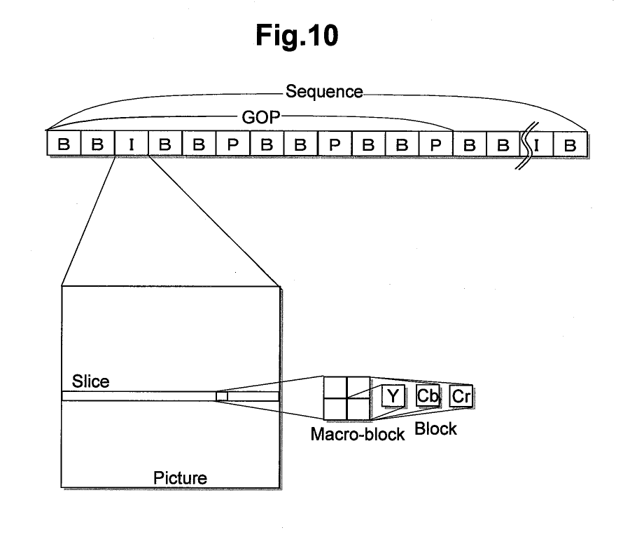

FIG. 10 is a diagram for explaining a hierarchical structure involved with a MPEG moving-picture coding scheme. As shown in FIG. 10, the MPEG moving-picture coding scheme has a structure of six layers of from Sequence corresponding to a whole moving picture to Block which is a processing unit of DCT (Discrete Cosine Transform). Specifically, the first layer is Sequence, the second is GOP (Group Of Picture), the third is Picture, the fourth is Slice, the fifth is Macro-block, and the sixth is Block. Although the hierarchical structure is based on the structure of moving pictures, it is relatively flexible concerning the number of pictures included in GOP or the number of macro-blocks included in Slice. However, it can be understood from FIG. 10 that the data size of one GOP substantially corresponds to a video data size of from I-frame to I-frame subsequent thereto.

### <<Configuration of Multiplexer/Demultiplexer>>

FIG. 2 is a diagram showing a configuration of a multiplexing control unit which materializes a multiplexer/demultiplexer built in a mobile phone terminal according to an embodiment of the invention.

The multiplexer/demultiplexer shown in FIG. 2 constitutes one of multimedia functions of a digital video camera system incorporated in the mobile phone terminal. Specifically, the multiplexing control unit 100 of FIG. 2 corresponds to the multiplexer/demultiplexer 336 of FIG. 1; the storage 110 and application program 170 of FIG. 2 correspond to the external memory device 15 of FIG. 1 and an application software program stored in the flash memory 14 respectively. Further, the camera 140, display 144, microphone 160 and speaker 164 of FIG. 2 correspond to the camera 17, LCD display device 16, microphone 18 and speaker 10 of FIG. 1, respectively. Moreover, in the Program Specification Information/Service Information (PSI/SI) control part 180 of FIG. 2, program specification information (PSI) and service information (SI) are stored as associated information from the terrestrial digital broadcast/tuner module 2 of FIG. 1.

The multiplexer/demultiplexer shown in FIG. 2 will be described below in detail.

The multiplexing control unit 100, which serves as a multiplexer/demultiplexer, is a module which executes DEMUX process at the time of reproduction and MUX process at the time of recording.

### <<Demultiplex Process in Reproduction>>

During DEMUX process at the time of reproduction, the multiplexing control unit 100 extracts video data and audio data from the storage 110 according to a packet identifier (PID) designated by the application program 170, and supplies the data to the video coding/decoding part 130 and audio coding/decoding part 150, respectively.

### <<Multiplex Process in Recording>>

During MUX process at the time of recording, the multiplexing control unit 100 multiplexes data produced by and sent from the video coding/decoding part 130, audio coding/decoding part 150 and PSI/SI control part 180, and stores the multiplexed data in the storage 110.

Specifically, image data captured by the camera 140 are subjected to up- or down-scaling, blend, color conversion, and other processing by the image-processing part 142, and then supplied to the video coding/decoding part 130 and compressed there, thereby making input image data to the multiplexing control unit 100. Audio data captured by the microphone 160 are subjected to analog-to-digital conversion, and processing for higher sound quality, etc. by the audio processing part 162, and then supplied to the audio coding/decoding part 150, and compressed there, thereby making input audio data to the multiplexing control unit 100. The PSI/SI control part 180 produces control information and additional information, which are required for reproduction, as described above. Therefore, input image data, input audio data, control information and additional information are subjected to MUX process for multiplex by the multiplexing control unit 100, and then stored in the storage 110.

Incidentally, the video coding/decoding part 130 is referred to as “video codec” which has both the function of an encoder and that of a decoder in terms of video signals. Likewise, the audio coding/decoding part 150 is referred to as “audio codec” which has both the function of an encoder and that of a decoder in terms of audio signals.

### <<Storage and Application Program>>

As the storage 110, not only a nonvolatile memory such as a flash memory built in the mobile phone terminal and an HDD (Hard Disk Drive), but also a removable nonvolatile memory which can be inserted in a slot of a mobile phone terminal are used.

The application program 170 executes designation of a packet identifier (PID) at the time of reproduction in one hand, and on the other, issues a notice of a user command, e.g. commands to start and stop reproduction. The application program 170 further conducts selection of reproduction- and recording-related module function of the multiplex-processing part 100, video coding/decoding part 130, image-processing part 142, audio coding/decoding part 150, audio processing part 162 and PSI/SI control part 180, the parameter setting thereof, and other things.

### <<Configuration of the Multiplex Controller>>

FIG. 3 is a diagram showing a configuration of the multiplexing control unit 100 according to an embodiment of the invention shown in FIG. 2.

The multiplexing control unit 100 shown in FIG. 3 includes: a multiplex-throughput-deciding part 200; a DEMUX-position-memorizing part 202; a multiplex-processing part 210; a TS buffer control part 220; a TS buffer 222; a PSI/SI data-memorizing part 230; a video buffer control part 240; a video buffer 242; a video-management-information-memorizing part 244; an audio buffer control part 250; an audio buffer 252; an audio-management-information-memorizing part 254; an I-frame-position-detecting part 260; and an I-frame-position-memorizing part 262.

In addition, in the multiplexing control unit 100 shown in FIG. 3, the TS buffer 222, video buffer 242 and audio buffer 252 are used for MUX process at the time of recording and DEMUX process at the time of reproduction. The memories to constitute the TS buffer 222, video buffer 242 and audio buffer 252 may be built-in RAMs incorporated in the mobile phone or SDRAMs (synchronous dynamic random access memories) attached outside the mobile phone.

First, the TS buffer control part 220 performs the memory control of the TS buffer 222, in which during DEMUX process, the TS buffer control part accumulates necessary transport stream data, which was taken out of the storage 110, in the TS buffer 222 according to the unoccupied capacity (unused memory capacity) of the TS buffer 222. On the other hand, during MUX process, the TS buffer control part 220 transfers a result output from the multiplex-processing part 210, which has been stored in the TS buffer 222, to the storage 110.

The video buffer control part 240 performs the memory control of the video buffer 242, in which during DEMUX process, the video buffer control part accumulates video data output by the multiplex-processing part 210 in the video buffer 242, and supplies the video data to the video coding/decoding part 130. On the other hand, during MUX process, the video buffer control part 240 accumulates data output from the video coding/decoding part 130 in the video buffer 242, and supplies the output data to the multiplex-processing part 210.

The video-management-information-memorizing part 244 is used to store a presentation time stamp (PTS), a decoding time stamp (DTS), and information output by the multiplex-processing part 210, which contains information about where to store an elementary stream in the video buffer 242 and its storage size, and which the video coding/decoding part 130 uses during DEMUX process. Also, the video-management-information-memorizing part 244 is used to store information output by the video coding/decoding part 130, which the multiplex-processing part 210 uses during MUX process. Now, it is noted that the presentation time stamp (PTS) shows a displayed time, and the decoding time stamp (DTS) shows the time of decode. The arrangement like this is made to cope with the fact that the displayed time and the time of decode, namely the time when image data are captured from the camera and the time of encode at the time of coding are different, which is attributed to introduction of a bi-directional prediction coded picture (B-picture, B-frame).

The audio buffer control part 250 performs the memory control of the audio buffer 252, in which during DEMUX process, the audio buffer control part accumulates audio data output by the multiplex-processing part 210 in the audio buffer 252, and supplies the audio data to the audio coding/decoding part 150. On the other hand, during MUX process, the audio buffer control part 250 accumulates data output from the audio coding/decoding part 150 in the audio buffer 252, and supplies the output data to the multiplex-processing part 210.

The audio-management-information-memorizing part 254 is used to store a presentation time stamp (PTS) showing the output time of audio, and information output by the multiplex-processing part 210, which contains information about where to store an elementary stream in the audio buffer 252 and its storage size, and which the audio coding/decoding part 150 uses during DEMUX process. Also, the audio-management-information-memorizing part 254 is used to store information output by the audio coding/decoding part 150, which the multiplex-processing part 210 uses during MUX process.

The memory content in the I-frame-position-memorizing part 262 has been produced by the I-frame-position-detecting part 260 at the time of recording, and also stored in the storage 110. As described above, the moving-picture coding schemes such as MPEG-2 and MPEG-4 use an intra-screen prediction coded picture (I-picture), a forward prediction coded picture (P-picture) and a bi-directional prediction coded picture (B-picture), in which the intra-screen prediction coded picture (I-picture) is an intra-frame/field coded image. Therefore, the I-frame is a frame which can be decoded per se without referring to another frame. The I-frame is used as a head frame at the time of a special operation referred to as “Trick Play”, e.g. fast-forward, fast-backward, skip, time search, or chapter skip. For the purpose of simplifying the detection of I-frame in a transport stream thereby to actualize a trick play with ease, the following of the contents of a TS packet including a presentation time stamp (PTS), decoding time stamp (DTS) and I-frame head data are stored in the I-frame-position-memorizing part 262 at the time of recording previously: the packet number from the top; the address; and the size of I-frame data.

At the time of reproduction, memory contents stored in the I-frame-position-memorizing part 262 are used to detect an I-frame. Specifically, during DEMUX process, the I-frame-position-detecting part 260 reads information about an I-frame from the storage 110 into the I-frame-position-memorizing part 262 and decides the head TS packet in performing DEMUX process.

The data size of a group of pictures (GOP) substantially corresponds to the size of video data from an I-frame to the subsequent one. Therefore, data of the transport stream of one GOP are included substantially in the size of the difference between the head address of an I-frame recorded on the I-frame-position-memorizing part 262 and that of the subsequent I-frame.

Hence, the multiplex-throughput-deciding part 200 decides an amount of data for execution of the multiplex process thereby to control the multiplex-processing part 210 while cooperating with the TS buffer control part 220, video buffer control part 240, audio buffer control part 250, I-frame-position-detecting part 260, etc. Further, the multiplex-throughput-deciding part 200 accepts user operations including Start Reproduction, Stop and Pause, which are provided from the application program 170.

According to the result of DEMUX process, the time stamp of video data to subsequently go through DEMUX process is memorized in the DEMUX-position-memorizing part 202 (Step 324 of FIG. 4). During the time when the multiplexing control unit 100 receives a direction of a trick play from the application program 170, the time designated concurrently with the trick play direction is stored in the DEMUX-position-memorizing part 202.

### <<Control Flow of the Demultiplex Process>>

FIG. 4 is a flowchart for explaining the flow of control of DEMUX process by the multiplexing control unit 100 according to the embodiment of the invention shown in FIG. 3.

The DEMUX process on a transport stream stored in the storage 110, in which the multiplexing control unit 100 shown in FIG. 3 is used, has a feature as follows.

That is, in DEMUX process of FIG. 4 (Step 312), the multiplexing control unit 100 executes the process in a plurality of frames (pictures) included in one GOP. As a result, a plurality of video frames and audio data are produced from the transport stream, which are supplied to the video decoder of the video coding/decoding part 130 and the audio decoder of the audio coding/decoding part 150.

However, before start of DEMUX process (Step 312), the multiplex-throughput-deciding part 200 makes, in advance, a judgment on whether a requirement of preparation for execution of DEMUX process is satisfied. In the advance judgment on whether the requirement of preparation for execution of DEMUX process is met, the storing states of the TS buffer 222 and video buffer 242 are checked (in Steps 300-308).

The control flow in the case of DEMUX process shown in FIG. 4 will be described in detail below.

The I-frame-position-detecting part 260 of the multiplexing control unit 100 detects the position of an I-frame just before the time stamp indicated by the DEMUX-position-memorizing part 202, and further calculates the difference in address between the I-frame position and the position of the subsequent I-frame. The transport stream corresponding to the address difference value will be an amount of data which must be stored in the TS buffer 222, namely an amount of data of one GOP. As the buffer memory capacity BMC required for the video buffer 242 corresponds to a set of remaining portions after the removal of a TS header from a TS packet, the approximate value thereof can be calculated by the following Expression 1.

BMC=Diff_Add_{—}I frame×(Size_{—}TS_Payload/Size_{—}TS_Packet) (Expression 1),

where Diff_Add_I frame represents the value of a difference between I-frames in address, i.e. inter-I-frame address difference value, Size_TS_Payload represents the payload size of the transport stream, and Size_TS_Packet represents the packet size of the transport stream.

The inter-I-frame address offset difference value Diff_Add_I frame contains audio data, and Program Specification Information (PSI)/Service Information (SI). Therefore, the difference value Diff_Add_I frame is larger than a size that is output actually. However, the way of MUX process of video data, audio data and Program Specification Information (PSI)/Service Information (SI) at the time of recording is not strictly defined. Therefore, in regard to contents recorded by other device, any strict calculation cannot be done because no algorithm is known. Such being the case, in Step 300 of FIG. 4, the amount of video data after DEMUX process on one GOP is estimated according to the Expression 1.

In the subsequent Step 302 of FIG. 4, the data amount of a transport stream which has been stored in the TS buffer 222 is acquired by the TS buffer control part 220.

Further, in the subsequent Step 304 of FIG. 4, the unoccupied capacity (unused memory capacity) of the video buffer 242 is acquired by the video buffer control part 240.

Thereafter, a comparison between the amount of video data of one GOP acquired in Step 300 and the amount of TS data stored in the TS buffer 222 acquired in Step 302 is made. Then, the execution of processing remains suspended in Step 306 of FIG. 4 until the stored TS data amount reaches or exceeds the data amount of one GOP.

Next, a comparison between the amount of video data of one GOP estimated in Step 300 and the unoccupied capacity (unused memory capacity) of the video buffer 242 acquired in Step 304 is made. Then, the execution of processing remains suspended in Step 308 of FIG. 4 until the unoccupied capacity (unused memory capacity) of the video buffer 242 reaches or exceeds the estimated video data amount of one GOP.

The completion of the processing of Step 308 means that the preparation of video data of one GOP in the TS buffer 222 has been completed, and an unoccupied region enough to output the one-GOP video data has been saved in the video buffer 242. As to audio data, as long as the bit rate is constant (the elementary stream size of each frame is constant), the buffer size to be saved in the audio buffer 252 can be specified. However, if a variable bit rate is adopted for audio data (the elementary stream size of each frame is variable), the audio buffer size cannot be estimated because there is not a memorizing part for DEMUX process of audio, which corresponds to the I-frame-position-memorizing part 262. However, the size as large as possible within an expected limit is saved. The reason for this is that the bit rate of audio data is about one tenth that of video data or smaller, and therefore the impact of a memory usage by audio data on the whole system is minuscule in comparison to video data.

Subsequently, in Step 312 of FIG. 4, the multiplex-processing part 210 is directed to perform DEMUX process on data of the one-GOP data amount. In this step, the following are designated: a storage destination address and size of the TS buffer 222, where input data is stored, storage destination addresses of the video buffer 242, audio buffer 252, and the PSI/SI data-memorizing part 230, video-management-information-memorizing part 244, and audio-management-information-memorizing part 254, which are to be storage destinations for output data.

In Step 314 of FIG. 4, it is judged whether or not DEMUX process in the multiplex-processing part 210 has been completed. If the judgment is judged as having been finished, in Step 316 of FIG. 4 the TS buffer control part 220 is directed to release the data of a transport stream, on which DEMUX process has been completed. After that, at the time when the execution of processing reaches the end of the file (Step 318), or when the multiplexing control unit has received a stop command or pause command from the application program 170 (Step 320), DEMUX process is terminated. In case that the multiplexing control unit has received a command for a trick play, such as fast-forward, fast-backward, skip, time search or chapter skip from the application program 170, a content of the DEMUX-position-memorizing part 202 is changed to a designated time in Steps 322 and 326. However, in case that no trick play command has been received from the application program 170, a content of the DEMUX-position-memorizing part 202 is changed to the head time stamp of the subsequent GOP, i.e. PTS (Presentation Time Stamp) of the subsequent I-frame in Steps 322 and 324.

In short, the following are judged: whether or not the execution of processing has reached the end of the file in Step 318 of FIG. 4; whether or not a stop or pause command has been received from the application program 170 in Step 320; and whether or not a trick key command has been received in Step 322.

### <<Control Flow of the Multiplex Process>>

FIG. 5 is a flowchart for explaining the flow of control of MUX process by the multiplexing control unit 100 according to the embodiment of the invention shown in FIG. 3.

The MUX process shown in FIG. 5, which includes producing a transport stream and storing it in the storage 110, has a feature as follows.

That is, in MUX process of FIG. 5 (Step 410), the multiplexing control unit 100 executes the process in a plurality of frames included in one GOP. Coded data from the video encoder of the video coding/decoding part 130 and coded data from the audio encoder of the audio coding/decoding part 150, and PSI/SI data produced by the PSI/SI control part 180 are input to the multiplex-processing part 210, in which a transport stream is produced according to MUX process. The transport stream produced in this way is stored in the storage 110.

Before start of MUX process (Step 410), the multiplex-throughput-deciding part 200 makes, in advance, a judgment on whether a requirement of preparation for execution of MUX process are satisfied. In the advance judgment on whether the requirement of preparation for execution of MUX process is met, the storing states of the video buffer 242, audio buffer 252, and TS buffer 222 are checked (in Steps 400-408).

Now, the details of MUX process in the case of reproduction shown in FIG. 5 will be described below.

In Step 400 of FIG. 5, MUX process is started on receipt of a notice of completion of storing of one-GOP video data on the video buffer 242 from the video buffer control part 240.

In Step 402 of FIG. 5, the amount of audio data stored in the audio buffer 252 and the frame number are acquired from the audio buffer control part 250. In Step 403, the execution of processing remains suspended until the frame number thus acquired reaches a number of audio frames required for MUX process.

In Step 404 of FIG. 5, the data amount of a transport stream after MUX process is calculated. Unlike DEMUX process, the multiplex-processing part 210 shown in FIG. 3 performs MUX process per se and as such, a correct data amount can be calculated. Specifically, the multiplexing control unit 100 calculates the data amount of a transport stream following a multiplex algorithm for video data, audio data and PSI/SI data.

In Step 406 of FIG. 5, the unoccupied capacity (unused memory capacity) of the TS buffer 222 is acquired from the TS buffer control part 220. In Step 408, the execution of processing remains suspended until the unoccupied capacity of the TS buffer 222 reaches or exceeds the after-MUX transport stream data amount calculated in Step 404.

When the unoccupied capacity of the TS buffer exceeds the transport stream data amount, the multiplex-processing part 210 is directed to perform MUX process on data of the after-MUX transport stream data amount in Step 410. In this step, the following are set: a storage destination address and size of the video buffer 242 for video data, where the input data is stored, a storage destination address and size of the audio buffer 252 for audio data, and storage destination addresses of the TS buffer 222, PSI/SI data-memorizing part 230, video-management-information-memorizing part 244, and audio-management-information-memorizing part 254, which are to be storage destinations for output data.

In Step 412 of FIG. 5, the execution of processing remains suspended until the multiplex-processing part 210 completes MUX process. When MUX process is completed, the video buffer control part 240 and audio buffer control part 250 are directed to release multiplexed data of the video buffer 242 and audio buffer 252 in Steps 414 and 416. In Step 418, at the time when the storage 110 is short in the memory capacity, or when the data amount stored in the storage reaches a maximum record size prescribed by a standard or specification, MUX process is terminated. In Step 420, MUX process is terminated when the application program 170 receives a stop command or pause command.

### <<Control Flow of Another Demultiplex Process>>

FIG. 6 is a flowchart for explaining the flow of control of another DEMUX process by the multiplexing control unit 100 according to the embodiment of the invention shown in FIG. 3.

Specifically, in the control flow shown in FIG. 6, Steps 506 to 514 of FIG. 6 are alternatives to Steps 306 to 314 in the control flow shown in FIG. 4.

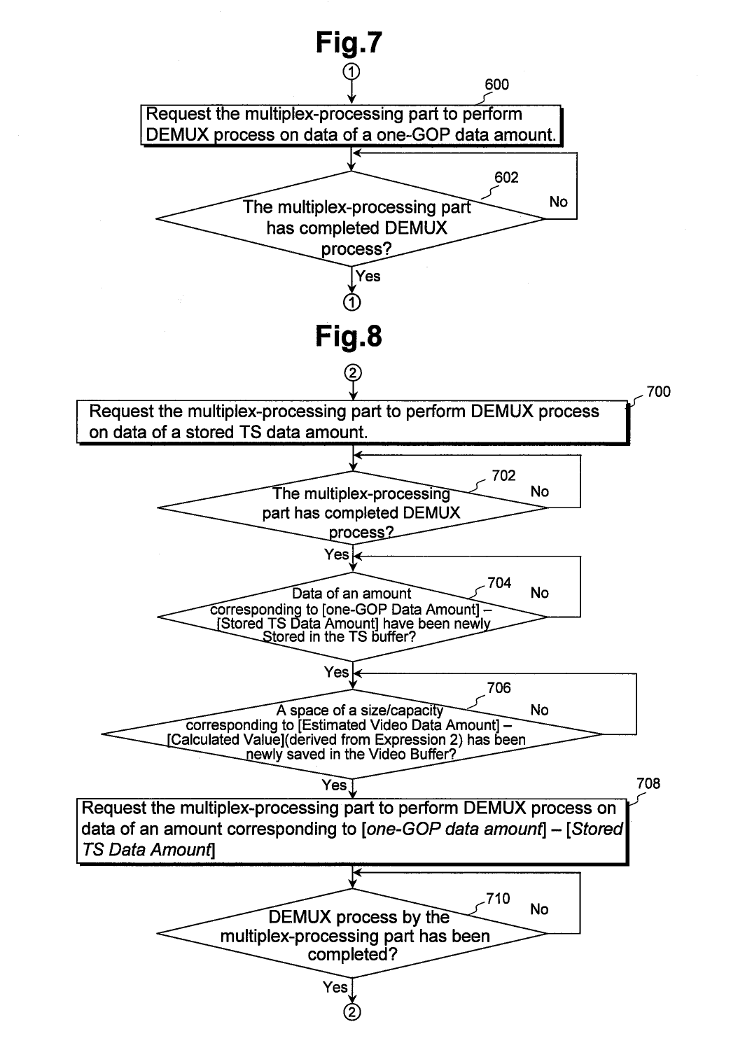

FIG. 7 is a flowchart for explaining the detail of DEMUX process 1 involved with Step 508 in the control flow shown in FIG. 6.

Like the above-described DEMUX process shown by FIG. 4, DEMUX process 1 on a transport stream stored in the storage 110 at the time of reproduction, which is shown in FIG. 7, and in which the multiplexing control unit 100 shown in FIG. 3 is used, has a feature as follows.

That is, in DEMUX process of FIG. 7 (Step 600), the multiplexing control unit 100 executes the process in a plurality of frames (pictures) included in one GOP. As a result, video frames and audio data of one GOP are produced from the transport stream, which are supplied to the video decoder of the video coding/decoding part 130 and the audio decoder of the audio coding/decoding part 150.

Before start of DEMUX process (Step 600), the multiplex-throughput-deciding part 200 makes, in advance, a judgment on whether a requirement of preparation for execution of DEMUX process is satisfied. In the advance judgment on whether the requirement of preparation for execution of DEMUX process is met, the storing states of the TS buffer 222 and video buffer 242 are checked (in Step 506 of FIG. 6).

Further, FIG. 8 is a flowchart for explaining the detail of DEMUX process 2 involved with Step 512 in the control flow shown in FIG. 6.

The DEMUX process on a transport stream stored in the storage 110 at the time of reproduction, which is shown in FIG. 8, and in which the multiplexing control unit 100 shown in FIG. 3 is used, has a feature as follows.

That is, in DEMUX process of FIG. 8 (Step 700), the multiplexing control unit 100 executes only the processing of a transport stream which has been stored in the TS buffer 222. As a result, video and audio data included in a stored transport stream are produced from the transport stream. These data are supplied to the video decoder of the video coding/decoding part 130 and the audio decoder of the audio coding/decoding part 150.

Before start of DEMUX process (Step 700), the multiplex-throughput-deciding part 200 makes, in advance, a judgment on whether a requirement of preparation for execution of DEMUX process is satisfied. For the advance judgment on whether the requirement of preparation for execution of DEMUX process with the data amount smaller than that of one GOP is satisfied, the following facts found out as results of the verification are utilized: the stored data amount of the TS buffer 222 is smaller than the data amount of one GOP (corresponding to the case of selecting “No” in Step 506 of FIG. 6); and the effective stored data amount of the TS buffer 222 is smaller than the unoccupied capacity of the video buffer 242 (corresponding to the case of selecting “Yes” in Step 510 of FIG. 6). In case that the completion of execution of DEMUX process of Step 700 is confirmed in Step 702, the execution of processing remains suspended until the remaining transport stream data which belong to the same GOP, but have not undergone DEMUX process are stored in the TS buffer 222 (Step 704 of FIG. 8). In addition, the execution of processing remains suspended until an unoccupied region equal to or larger than an estimated video data amount included in the remaining transport stream data which belong to the same GOP, but have not gone through DEMUX process is saved in the video buffer 242 (Step 706 of FIG. 8). After such suspension, DEMUX process on the remaining transport stream data which belong to the same GOP, but have not experienced DEMUX process is started (Step 708 of FIG. 8).

FIG. 9 is a flowchart for explaining the detail of DEMUX process 3 involved with Step 514 in the control flow shown in FIG. 6.

The DEMUX process on a transport stream stored in the storage 110 at the time of reproduction, which is shown in FIG. 9, and in which the multiplexing control unit 100 shown in FIG. 3 is used, has a feature as follows.

That is, in DEMUX process of FIG. 9 (Step 800), the multiplexing control unit 100 executes only the processing of the amount of data included in one GOP and corresponding to the unoccupied capacity of the video buffer 242. As a result, from the transport stream, video data corresponding to the unoccupied capacity of the video buffer 242 and audio data included in the transport stream thereof are produced. These data are supplied to the video decoder of the video coding/decoding part 130 and the audio decoder of the audio coding/decoding part 150.

Before start of DEMUX process of transport stream data corresponding to the unoccupied capacity of the video buffer 242 (Step 800), the multiplex-throughput-deciding part 200 makes, in advance, a judgment on whether a requirement of preparation for execution of DEMUX process is satisfied. For the advance judgment on whether the requirement of preparation for execution of DEMUX process is met, the following facts found out as results of the verification are utilized: the stored data amount of the TS buffer 222 is smaller than the data amount of one GOP (corresponding to the case of selecting “No” in Step 506 of FIG. 6); and the effective stored data amount of the TS buffer 222 is larger than the unoccupied capacity of the video buffer 242 (corresponding to the case of selecting “No” in Step 510 of FIG. 6). In case that the completion of execution of DEMUX process of Step 800 is confirmed in Step 802, the execution of processing remains suspended until the remaining transport stream data which belong to the same GOP, but have not undergone DEMUX process are stored in the TS buffer 222 (Step 804 of FIG. 9). In addition, the execution of processing remains suspended until an unoccupied region equal to or larger than the data amount of an estimated video data included in the remaining transport stream which belong to the same GOP, but have not gone through DEMUX process is saved in the video buffer 242 (Step 806 of FIG. 9). After such suspension, DEMUX process on the remaining transport stream data which belong to the same GOP, but have not experienced DEMUX process is started (Step 808 of FIG. 9).

Now, the details of DEMUX process shown with reference to FIGS. 6 to 9 will be described below.

In Step 506 of FIG. 6, a comparison between the TS data amount acquired in Step 302 and stored in the TS buffer 222 and the data amount of one GOP acquired in Step 300 is made. Also, a comparison between the unoccupied capacity (unused memory capacity) of the video buffer acquired in Step 304 and the amount of video data of one GOP acquired in Step 300 is made. In the case where the following two requirements are satisfied, DEMUX process 1 of Step 508 is executed. The first is that the amount of TS data stored in the TS buffer 222 and acquired in Step 302 reaches or exceeds the one-GOP data amount acquired in Step 300. The second is that the unoccupied capacity (unused memory capacity) of the video buffer acquired in Step 304 reaches or exceeds the one-GOP video data amount acquired in Step 300.

In the processing of Step 600 shown in FIG. 7 corresponding to DEMUX process 1 of Step 508 in the control flow of FIG. 6, the multiplex-processing part 210 is directed to perform DEMUX process on the data amount of one GOP as in Step 312 of FIG. 4. In this step, the following are designated: a storage destination address and size of the TS buffer 222, where input data is stored, and storage destination addresses of the video buffer 242, audio buffer 252, PSI/SI data-memorizing part 230, video-management-information-memorizing part 244, and audio-management-information-memorizing part 254, which are to be storage destinations for output data.

In Step 602 shown in FIG. 7, it is judged whether or not DEMUX process has been completed by the multiplex-processing part 210, as in Step 314 of FIG. 4. If DEMUX process is judged as having been completed, in Step 316 of FIG. 6 the TS buffer control part 220 is directed to release transport stream data, on which DEMUX process has been completed exactly in the same way as in Step 316 of FIG. 4. The processes of Steps 318, 320, 322, 324 and 326 are exactly the same as those shown in FIG. 4 and therefore, the descriptions thereof are skipped here.

In Step 506 of FIG. 6, in the case where the two requirements described above are not satisfied, the process of Step 510 of FIG. 6 is executed. Specifically, in the process of Step 510 of FIG. 6, the effective stored data amount ESD determined by removing the TS header from a TS data amount STSD stored in the TS buffer 222 which has been acquired in Step 302 is first calculated according to the following Expression 2.

ESD=STSD×(Size_{—}TS_Payload/Size_{—}TS_Packet) (Expression 2),

where ESD represents the effective stored data amount, STSD represents the amount of TS data which has been stored in the TS buffer 222, Size_TS_Payload represents the payload size of a transport stream, and Size_TS_Packet represents the packet size of the transport stream.

Also, in the process of Step 510 of FIG. 6, it is judged whether or not the effective stored data amount ESD of the TS buffer 222 calculated according to the Expression 2 is smaller than the unoccupied capacity (unused memory capacity) VCVBM of the video buffer 242, which has been acquired in Step 304 of FIG. 4.

If it is judged in Step 510 of FIG. 6 that the effective stored data amount ESD of the TS buffer 222 according to Expression 2 is smaller than the unoccupied capacity VCVBM of the video buffer 242 acquired in Step 304 of FIG. 4, DEMUX process 2 of Step 512 is executed.

In the process shown in FIG. 8, which corresponds to DEMUX process 2 of Step 512 in the control flow of FIG. 6, in Step 700 the multiplex-processing part 210 is directed to perform DEMUX process on data of a transport stream which has been stored in the TS buffer 222.

In Step 702 of FIG. 8, it is judged whether or not DEMUX process by the multiplex-processing part 210 has been completed.

If it is judged in Step 702 of FIG. 8 that the process has been completed, the execution of processing remains suspended in Step 704 of FIG. 8 until the remaining transport stream data which belong to the same GOP, but have not experienced DEMUX process are stored in the TS buffer 222. Incidentally, the amount of the remaining transport stream data which belong to the same GOP, but have not undergone DEMUX process is equal to the result of subtraction of the amount of transport stream data which have been stored in the TS buffer 222 from the amount of transport stream data which belong to the same GOP.

After that, in Step 706 of FIG. 8, the execution of processing remains suspended until an unoccupied capacity (unused memory capacity) representing the amount of estimated video data included in a transport stream which belong to the same GOP, but have not been subjected to DEMUX process is saved in the video buffer 242. Specifically, in Step 706 of FIG. 8, the execution of processing remains suspended until the unoccupied capacity (unused memory capacity) equal to or larger than an estimated video data amount is saved in the video buffer 242, provided that the estimated video data amount is a remainder resulting from the subtraction of the effective stored data amount ESD of TS data having been stored in the TS buffer 222 in Step 302 from the one-GOP video data amount estimated in Step 300, and the effective stored data amount ESD_is calculated according to the Expression 2.

After the required unoccupied capacity is saved in the video buffer 242 in Step 706 of FIG. 8, a direction to perform DEMUX process on the remaining transport stream data is issued to the multiplex-processing part 210 in Step 708 of FIG. 8. As described above, the remaining transport stream data amount can be consequently gained by subtracting, from the data amount of a transport stream containing one GOP acquired in Step 300, the amount of a transport stream data already stored in the TS buffer 222, which is acquired in Step 302. In this step, the following are designated: a storage destination address and size of the TS buffer 222, where input data is stored, and storage destination addresses of the video buffer 242, audio buffer 252, the PSI/SI data-memorizing part 230, video-management-information-memorizing part 244, audio-management-information-memorizing part 254, which are to be storage destinations for output data.

In Step 710 of FIG. 8, it is judged whether or not DEMUX process in the multiplex-processing part 210 has been completed. If DEMUX process is judged as having been completed, the execution of processing is shifted to Step 316 of FIG. 6, and the TS buffer control part 220 is directed to release data of a transport stream on which DEMUX process has been completed.

When it is judged in Step 510 of FIG. 6 that the effective stored data amount ESD of TS buffer 222 determined by the Expression 2 is larger than the unoccupied capacity VCVBM of the video buffer 242 gained in Step 304 of FIG. 4, DEMUX process 3 of Step 514 is executed.

In the process shown in FIG. 9 corresponding to DEMUX process 3 of Step 514 in the control flow of FIG. 6, the multiplex-processing part 210 is directed to perform DEMUX process on, of TS data which have been stored in the TS buffer 222, only a data amount V_demux, which is calculated according to the following Expression 3 in Step 800.

V_{—}demux=Round(VCVBM/Size_{—}TS_Payload)×(Size_{—}TS_Packet) (Expression 3),

where V_demux represents a data amount targeted for DEMUX process, which the multiplex-processing part 210 is directed to conduct, Round represents an operation to round off a number to unit, VCVBM represents the unoccupied capacity of the video buffer 242, Size_TS_Payload represents the payload size of a transport stream, and Size_TS_Packet represents the packet size of a transport stream.

In Step 802 of FIG. 9, it is judged whether or not DEMUX process in the multiplex-processing part 210 has been completed.

If DEMUX process is judged as having been completed in Step 802 of FIG. 9, the execution of processing remains suspended in Step 804 of FIG. 9 until the remaining video data, which belong to the same GOP, but have not gone through DEMUX process, are stored in the TS buffer 222. Incidentally, the amount of the remaining transport stream data which belong to the same GOP, but have not undergone DEMUX process is equal to the result of subtraction of a transport stream data amount, on which DEMUX process has been completed and which is calculated according to the Expression 3, from the amount of transport stream data belonging to the same GOP.

After that, in Step 806 of FIG. 9, the execution of processing remains suspended until the unoccupied capacity (unused memory capacity) corresponding to the amount of estimated video data contained in a transport stream which belongs to the same GOP, but has not gone through DEMUX process is saved in the video buffer 242. Specifically, in Step 806 of FIG. 9, the execution of processing remains suspended until the unoccupied capacity (unused memory capacity) equal to or larger than a transport stream data amount is saved in the video buffer 242, provided that the transport stream data amount is a remainder resulting from the subtraction of the amount of data, on which DEMUX process has been completed and which is calculated according to the Expression 3, from the one-GOP video data amount estimated in Step 300.

After the required unoccupied capacity is saved in the video buffer 242 in Step 806 of FIG. 9, a direction to perform DEMUX process on the remaining video data is issued to the multiplex-processing part 210 in Step 808 of FIG. 9. As described above, the remaining video data is calculated from the one-GOP video data amount estimated in Step 300 according to the following Expression 4.

LTSD=(Diff_Add_{—}I frame−V_{—}demux)×(Size_{—}TS_Payload/Size_{—}TS_Packet) (Expression 4),

where the first term (Diff_Add_I_frame−V_demux) on the right side is the amount of transport stream data on which DEMUX process has not been performed in the same GOP, and is equivalent to the amount of data stored in Step 804. Multiplying the first term by (Size_TS_Payload/Size_TS_Packet), the data amount is converted to that in a payload portion where video data are stored.

In the case of directing the multiplex-processing part 210 to perform DEMUX process, the following are designated: a storage destination address and size of the TS buffer 222, where input data is stored, and storage destination addresses of the video buffer 242, audio buffer 252, PSI/SI data-memorizing part 230, video-management-information-memorizing part 244, and audio-management-information-memorizing part 254, which are to be storage destinations for output data.

In Step 810 of FIG. 9, it is judged whether or not DEMUX process in the multiplex-processing part 210 has been completed. If DEMUX process is judged as having been completed, the execution of processing is shifted to Step 316 of FIG. 6, and the TS buffer control part 220 is directed to release transport stream data on which DEMUX process has been completed.

While the invention made by the inventor has been described above based on the embodiments concretely, it is not limited to the embodiments. It will be appreciated that various changes and modifications may be made without departing from the scope of the invention.

In other words, in regard to the various embodiments of the invention described above, the taking of a moving picture by use of a digital video camera system has been described. However, the invention is applicable to other processes.

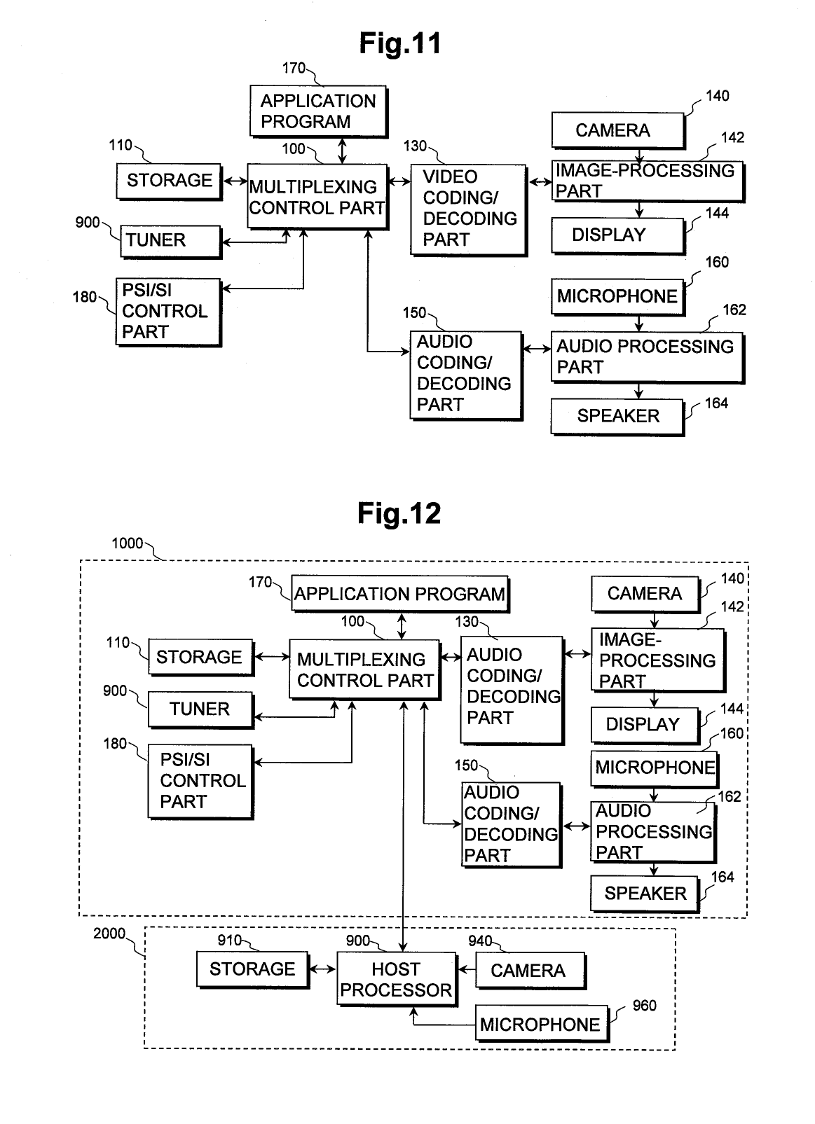

FIG. 11 is a diagram showing a configuration that a tuner 900 for receipt of a television broadcast is connected with the system of FIG. 2.

The embodiments shown by FIGS. 2 to 9 have been described taking a digital video camera system as an example. However, the invention is not limited to the embodiments. As shown in FIG. 11, the following are possible: to enter a transport stream (TS) received through the tuner 900 into the multiplexing control unit 100; and to directly record on the storage 110. Also, it is possible to record on the storage 110 after transcode by use of the video codec 130 and audio codec 150.

FIG. 12 is a diagram showing, on the assumption that the system of FIG. 11 is an independent coprocessor system 1000, a configuration in which the coprocessor system 1000 is connected with the host processor 900 of the host system 2000.

With the configuration of FIG. 12, it is possible to read contents in the storage 910 connected on the side of the host processor system 2000 into the multiplexing control unit 100 of the coprocessor system 1000 to conduct DEMUX and playback processes. Also, it is possible to input data captured by the camera 940 and microphone 960 connected on the side of the host processor system 2000 to the image-processing part 142 and audio processing part 162 and then actualize MUX process and a recording process by use of the multiplexing control unit 100.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. A multiplexing control unit operable to execute a multiplex process, comprising:
a transport stream buffer;
a multiplex-processing part;
a video buffer capable of storing coded video data;
an audio buffer capable of storing coded audio data,
wherein the multiplex-processing part is supplied with the coded video data and coded audio data from the video buffer and audio buffer respectively, and executes a multiplex process on the coded video data and coded audio data,
transport stream data produced by the multiplex process by the multiplex-processing part, and subjected to moving-picture compression coding can be stored in the transport stream buffer,
supplies of the coded video data and coded audio data to the multiplex-processing part are executed in sets of more than one frame processed according to the moving-picture compression coding,
before start of execution of the multiplex process, it is judged in the multiplexing control unit whether or not a requirement of preparation for execution of the multiplex process is satisfied, and
the judgment on whether or not the requirement of preparation for the execution is satisfied is made by checking a storing state of the coded video data in the video buffer, a storing state of the coded audio data in the audio buffer, and a storing state of the transport stream data in the transport stream buffer.

2. The multiplexing control unit according to claim 1, wherein the more than one frame processed in the multiplex process includes an I-frame which is an intra-screen prediction coded picture in a moving-picture coding scheme, a P-frame which is a forward prediction coded picture and a B-frame which is a bi-directional prediction coded picture, and
the more than one frame is coded video data at least including the I-frame to a frame just before a next I-frame.

3. The multiplexing control unit according to claim 2, wherein the more than one frame corresponds to one group of pictures substantially.

4. The multiplexing control unit according to claim 3, wherein the coded video data which can be stored in the video buffer, the coded audio data which can be stored in the audio buffer are based on image data captured by a camera of a digital video camera system and audio data captured by a microphone respectively.

5. The multiplexing control unit according to claim 4, wherein the image data captured by the camera is converted into the coded video data by a video coding/decoding part, and
the audio data captured by the microphone is converted into the coded audio data by an audio coding/decoding part.

6. The multiplexing control unit according to claim 3, further comprising a data-memorizing part capable of storing program information as broadcast-associated information,
wherein the coded video data and coded audio data are supplied to the multiplex-processing part from the video buffer and audio buffer, respectively, and
the program information is supplied from the data-memorizing part, whereby the multiplex-processing part executes the multiplex process on the coded video data, coded audio data and the program information.

7. The multiplexing control unit according to claim 1, wherein the judgment on whether or not the requirement of preparation for the execution is satisfied is made by a judging part inside the multiplexing control unit.

8. A multiplexing control unit operable to execute a demultiplex process, comprising:
a transport stream buffer;
a multiplex-processing part;
a video buffer; and
an audio buffer,
wherein transport stream data subjected to moving-picture compression coding, on which the multiplex-processing part executes the demultiplex process, can be stored in the transport stream buffer,
the multiplex-processing part executes the demultiplex process on the transport stream data stored in the transport stream buffer, whereby coded video data and coded audio data can be produced,
the coded video data produced by the multiplex-processing part can be stored in the video buffer, and the coded audio data produced by the multiplex-processing part can be stored in the audio buffer,
the demultiplex process by the multiplex-processing part is executed in sets of more than one frame processed according to the moving-picture compression coding,
before start of execution of the demultiplex process, it is judged in the multiplex-processing part whether or not a requirement of preparation for execution of the demultiplex process is satisfied, and
the judgment on whether or not the requirement of preparation for the execution is satisfied is made by checking a storing state of the transport stream data of the transport stream buffer, and a storing state of the decoded video data of the video buffer.

9. The multiplexing control unit according to claim 8, wherein the more than one frame processed according to the demultiplex process includes an I-frame which is an intra-screen prediction coded picture in a moving-picture coding scheme, a P-frame which is a forward prediction coded picture and a B-frame which is a bi-directional prediction coded picture, and
the more than one frame is coded video data at least including the I-frame to a frame just before a next I-frame.

10. The multiplexing control unit according to claim 9, wherein the more than one frame corresponds to one group of pictures substantially.

11. The multiplexing control unit according to claim 10, wherein even in case that the requirement of preparation for the execution is judged not to be perfectly satisfied, execution of the demultiplex process is started only on the transport stream data stored in the transport stream buffer by confirming that the data amount of the transport stream data stored in the transport stream buffer is smaller than a data amount of the one group of pictures, and confirming that an unoccupied capacity of the video buffer is larger than an effective stored data amount of the transport stream buffer.

12. The multiplexing control unit according to claim 11, wherein after completion of the execution of the demultiplex process only on the transport stream data stored in the transport stream buffer, execution of the demultiplex process on the remaining transport stream data stored in the transport stream buffer is not started until remaining transport stream data of the one group of pictures have been stored in the transport stream buffer, and a required unoccupied capacity has been saved in the video buffer.

13. The multiplexing control unit according to claim 12, wherein even in case that the requirement of preparation for the execution is judged not to be perfectly satisfied, after confirming that the data amount of the transport stream data stored in the transport stream buffer is smaller than a data amount of the one group of pictures, and confirming that an unoccupied capacity of the video buffer is smaller than an effective stored data amount of the transport stream buffer, execution of the demultiplex process is started only on the transport stream data stored in the transport stream buffer and corresponding to the unoccupied capacity of the video buffer.

14. The multiplexing control unit according to claim 13, wherein after completion of the execution of the demultiplex process only on the transport stream data stored in the transport stream buffer, and corresponding to the unoccupied capacity of the video buffer, execution of the demultiplex process on the remaining transport stream data stored in the transport stream buffer is not started until remaining transport stream data of the one group of pictures have been stored in the transport stream buffer, and a required unoccupied capacity has been saved in the video buffer.

15. The multiplexing control unit according to claim 14, wherein the coded video data, coded audio data produced by the multiplex-processing part are converted into decoded video data and decoded audio data by a video coding/decoding part and an audio coding/decoding part respectively.

16. The multiplexing control unit according to claim 15, wherein the transport stream data which can be stored in the transport stream buffer is based on data acquired from a storage of a portable system.

17. The multiplexing control unit according to claim 15, further comprising a data-memorizing part capable of storing program information as broadcast-associated information,
wherein the multiplex-processing part executes the demultiplex process on the transport stream data stored in the transport stream buffer, whereby the coded video data and coded audio data can be produced, and the program information can be produced, and
the program information produced by the multiplex-processing part can be stored in the data-memorizing part.

18. The multiplexing control unit according to claim 8, wherein the judgment on whether or not the requirement of preparation for the execution is satisfied is made by a judging part inside the multiplexing control unit.
